(19) United States
(12) Patent Application Publication
(10) Pub. No.: US 2005/0176461 A1
(43) Pub. Date: Aug. 11, 2005

(54) Modular communication system

(76) Inventors: Stephen O. Bozzone, Lauderhill, FL (US); Bonnie J. Bachman, Davie, FL (US); Ryan M. Nilsen, Pompano, FL (US)

Correspondence Address: AKERMAN SENTERFITT, P.O. BOX 3188, WEST PALM BEACH, FL, 33402-3188, US

(21) Appl. No.: 10/776,658

(22) Filed: Feb. 11, 2004

(51) Int. Cl. H04M 1/00

(52) U.S. Cl. 455/551

(57) ABSTRACT

A modular communication system (10) can include an adaptable communication module (12) having a transceiver (13) coupled to a processor (14) and memory (20), and a first interface block (24) coupled to the processor, and a host device (30) having a power source (36), a user interface (34), and a second interface block (46). The host device can be among a plurality of host devices having different user interfaces and the processor is adaptable to control the different user interfaces when the first interface block recognizes the second interface block. The module can further include a DSP (16) and a display (18) coupled to the processor as well as an antenna (11). A host device can be a phone, a wristwatch, a camera or video phone, an MP3 player, a heart rate monitor, a game controller, a toy, a stroller, or a crib among other devices.

### CROSS-REFERENCE TO RELATED APPLICATIONS

Not applicable

### FIELD OF THE INVENTION

This invention relates generally to communication devices, and more particularly to a communication module adaptable for use with devices having different interfaces.

### BACKGROUND OF THE INVENTION

Consumers today have many stand-alone digital devices and other items that could be enhanced with the addition of mobile communication capability. A more recent trend has been to integrate mobile communication capabilities with digital devices. Personal digital assistants (PDAs) and now digital cameras and video recorders are integrating mobile phone capabilities. For example, a digital camera could use wireless data communication to share photos with others having a similar device or anyone having an email account. An MP3 player integrated with a mobile phone device and strapped to a user's arm while jogging or exercising enables the user to make and receive phone calls with the same device that allows them to listen to music. Unfortunately, such devices are typically costly, unnecessarily large, and limited to their intended usage as an integrated device.

The solution presented so far from equipment manufactures is to either make mobile phones bigger and bulkier by adding and integrating the desired functionality or by providing an accessory to connect to the phone. The trouble with this approach is a compromise or sacrifice in the intended usability for the task or activity provided by the combined device. A cell phone that allows one to play games usually has rather small screens and unfriendly user interfaces. Alternatively, a handheld gaming device having a phone built into it creates a dedicated device with limited functions that may not suit the user in all situations. Either alternative does not provide sufficient flexibility for the user.

Furthermore, there are many other items other than portable digital electronics that can benefit from mobile communications. For example, toys, cribs, hospital beds, gurneys, and strollers could benefit from mobile communication in terms of providing critical information to caretakers and educational information to users of such items.

### SUMMARY OF THE INVENTION

A modular communication module in accordance with an embodiment of the present invention is adaptable with use on different host devices having different user interfaces. Furthermore, such a module can be used on products that have not traditionally included electronics or communication components.

In one embodiment of the present invention, a modular wireless communication module can include a transceiver coupled to a processor and memory, and an interface block coupled to the processor. The processor can be programmed to operate in accordance with an identifier signal received from at least one among a plurality of host devices each having different user interfaces. The module can further include a digital signal processor and a display coupled to the processor as well as an antenna. The processor can control the operation of a given host device once coupled to the given host device and the display can present content associated with a given host device.

In a second embodiment of the present invention, a modular communication system can include a modular wireless communication module having a transceiver coupled to a processor and memory, and a first interface block coupled to the processor, and a host device having a power source, a user interface, and a second interface block. The host device can be one among a plurality of host devices having different user interfaces and the processor is adaptable to control the different user interfaces when the first interface block recognizes the second interface block of a given host device. A given host device among the plurality of host devices can be a monolith phone, a flip phone, a wristwatch communicator, a camera phone, a video phone, a qwerty key-board host device, a pendant-shaped host device, an MP3 player sport device, a heart rate monitor, a game controller host, a toy, a stroller, or a crib.

In a third embodiment of the present invention, an adaptable communication module can include a transceiver a radio communication transceiver having a processor programmed to operate with and control a plurality of different host devices having different user interfaces and an interface block coupled to the processor for detecting at least one among the plurality of host devices. The adaptable communication module further include a presentation device coupled to the processor for presenting information associated with the adaptable communication module and a given host device among the plurality of host devices. The presentation device can be a display, a speaker, or other presentation device. Each of the host devices can include an interface block for interfacing with the interface block of the adaptable communication module.

In a fourth embodiment of the present invention, a host device for mating with a modular wireless communication module having a first interface block and a transceiver coupled to a processor can include a power source, a user interface coupled to the power source, and a second interface block. The host device can be one among a plurality of host devices having different user interfaces controlled by the processor when the first interface block recognizes the second interface block of the host device.

In yet another embodiment, a method of reusing a modular wireless communication module among a plurality of different host devices can include the steps of selectively coupling the modular wireless communication module with a first host device having a first user interface and recognizing the first host device to enable a processor within the modular wireless communication module to control the first host device and the first user interface. The method can further include the step of selectively coupling the modular wireless communication module with at least a second host device having a second user interface and recognizing the second host device to enable the processor within the modular wireless communication module to control the second host device and the second user interface. Note that the first and second host devices and their respective user interfaces can appear and function differently from each other.

### BRIEF DESCRIPTION OF THE DRAWINGS

FIG. 1 is a block diagram of a modular communication system in accordance with the present invention.

FIG. 2 is a modular communication module or an adaptable communication module in accordance with present invention.

FIG. 3 illustrates the adaptable communication module of FIG. 2 used in conjunction with a monolith shaped radio in accordance with the present invention.

FIG. 4 illustrates a flip phone host device that can be used with the adaptable communication module of FIG. 2 in accordance with the present invention.

FIG. 5 illustrates the adaptable communication module of FIG. 2 used in conjunction with a wristwatch in accordance with the present invention.

FIG. 6 illustrates the adaptable communication module of FIG. 2 used in conjunction with a camera or video phone in accordance with the present invention.

FIG. 7 illustrates the adaptable communication module of FIG. 2 used in conjunction with a qwerty keyboard configured host device in accordance with the present invention.

FIG. 8 illustrates the adaptable communication module of FIG. 2 used in conjunction with a pendant shaped host device in accordance with the present invention.

FIG. 9 illustrates the adaptable communication module of FIG. 2 used in conjunction with a gaming configured host device in accordance with the present invention.

FIG. 10 illustrates the adaptable communication module of FIG. 2 used in conjunction with an MP3 host device in accordance with the present invention.

FIG. 11 illustrates the adaptable communication module of FIG. 2 used in conjunction with a heart rate monitor host device in accordance with the present invention.

FIG. 12 illustrates the adaptable communication module of FIG. 2 used in conjunction with a crib as a host device in accordance with the present invention.

FIG. 13 illustrates the adaptable communication module of FIG. 2 used in conjunction with a stroller as a host device in accordance with the present invention.

FIG. 14 illustrates the adaptable communication module used in conjunction with a police themed toy figurine as a host device in accordance with the present invention.

FIG. 15 illustrates the adaptable communication module used in conjunction with a firefighter themed toy figurine as a host device in accordance with the present invention.

FIG. 16 illustrates the adaptable communication module used in conjunction with a football player themed toy figurine as a host device in accordance with the present invention

FIG. 17 is a flow chart illustrating a method of reusing a modular wireless communication module among a plurality of different host devices in accordance with the present invention.

### DETAILED DESCRIPTION OF THE DRAWINGS

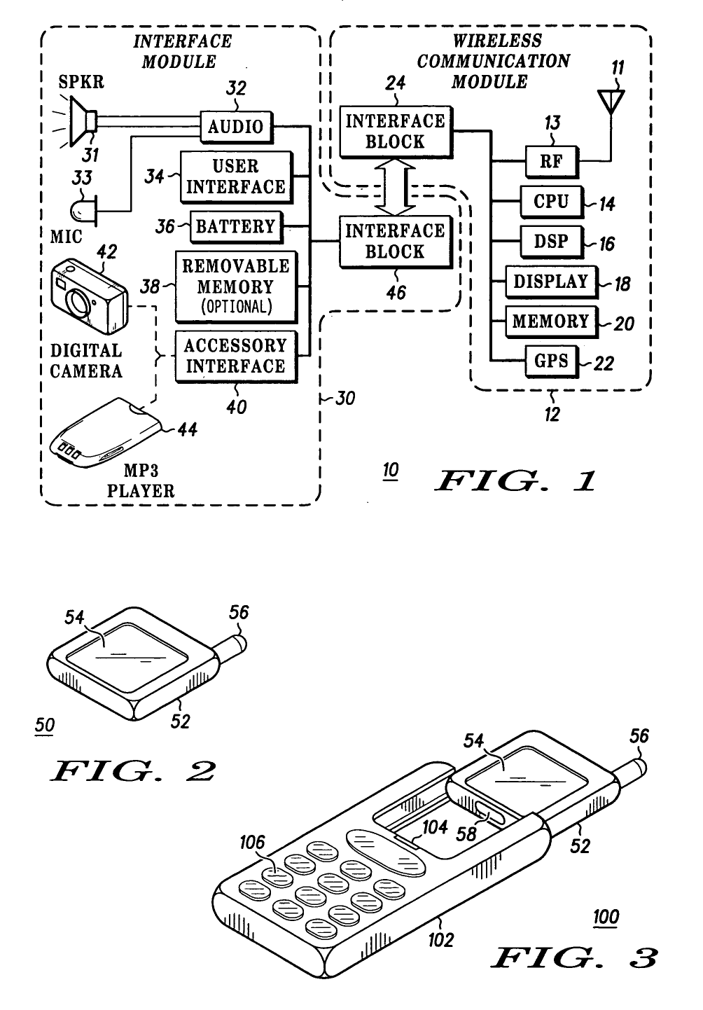

Referring to FIG. 1, a block diagram of a modular communication system 10 is shown. The system 10 can include a modular communication module or adaptable communication module 12 and a host device 30. The adaptable communication module 12 can include, for example, a radio frequency (RF) module 13 such as those found in conventional cellular phones, a two-way trunked radio, a home cordless phone, a two-way paging device, a satellite phone, or a Motorola iDEN phone, or any number of other radio devices. The RF module can include an encoder, transmitter as well as a receiver and decoder for receiving and decoding information sent to the adaptable communication module 12. The adaptable communication module 12 can further include an antenna 11, a processor 14 such as a microprocessor and a memory 20. The adaptable communication module 12 can also optionally include a digital signal processor 16, a presentation device 18 such as a display and a GPS receiver 22 useful for location tracking. The display can be coupled to a graphical user interface program or driver (not shown). The module 12 can further include an interface block 24.

Referring once again to FIG. 1, the host device 30 can be any number of products such as a monolith phone, a flip phone, a wristwatch communicator, a camera phone, a video phone, a qwerty key-board host device, a pendant-shaped host device, an MP3 player sport device, a heart rate monitor, a game controller host, a toy, a stroller, or a crib to name a few. The host device 30 can include a power source 36 such as a battery, a user interface 34, and a second interface block 46 for interfacing with the interface block 24 of the adaptable communication module 12. The host device can be one among a plurality of host devices having different user interfaces and the processor 14 (and optionally the DSP 16) of the module 12 is adaptable to control the different user interfaces when the first interface block 24 recognizes the second interface block 46 of a given host device. The host device 30 can optionally include a presentation and/or input device such as an audio module 32 coupled to speaker 31 and microphone 33. The host device can also optionally include removable memory 38, an accessory interface 40 and a plurality of accessories such as a digital camera 42 or an MP3 player 44 as examples.

Thus, as presented, the adaptable communication module 12 provides the core functionality of the modular communication system and can be thought of as an engine that powers any number of interface module devices (camera, gaming console, phone, MP3 player, etc.) that are in effect different chassis for the engine. The adaptable communication module 12 can conform to the user's preference, lifestyle or specific activity the user is performing. Rather than spending duplicative costs for a core function that can be modular, a single core device can be adapted to be used with a plurality of host devices or accessories.

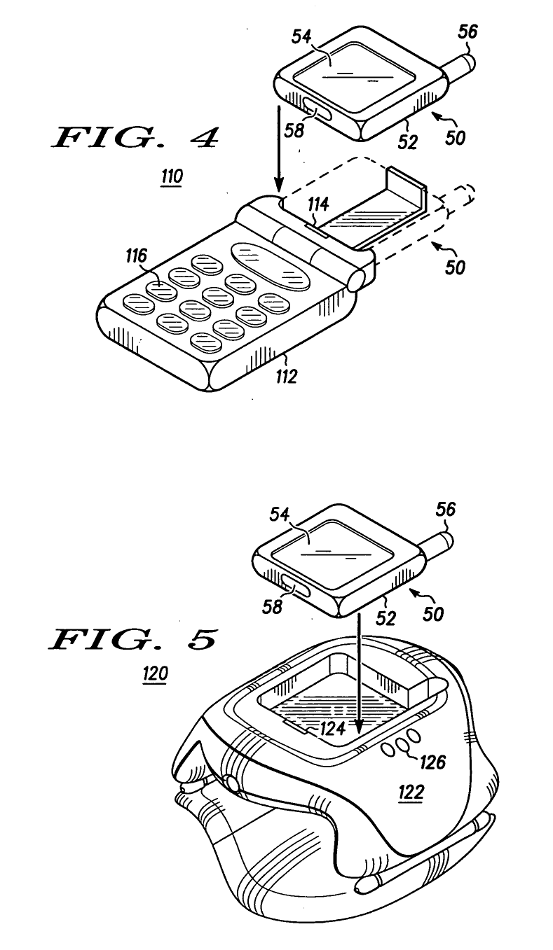

Referring to FIGS. 2-13, an adaptable communication module 50 simply slides into whichever accessory or host device the user wants to use for a given time or activity. The module 50 can be enclosed in a housing 52 having an optional display 54 and an external or internal antenna 56. The module 50 may also include an interface 58. By keeping the more expensive components in the communication module 50, the user does not pay for having an LCD, RF chip, DSP, antenna, memory, or other core component in each device. The battery can also reside in the host device so that it can be charged when using another accessory to be ready whenever the user wants to take it with them. The adaptable communication systems illustrated in FIGS. 3-13 are merely a few examples of the many configurations the module 50 can be used with.

A monolith configured radio 100 as shown in FIG. 3 can include a host portion 102 having a user interface 106 and an interface block 104 for mating with the interface block 58 of the module 50. The user interface 106 can include a plurality of keypads and keys for a variety of functions commonly used on phones. Another phone configuration is shown in FIG. 4. A flip phone configured radio 110 can include a host portion 112 having a user interface 116 and an interface block 114 for mating with the interface block 58 of the module 50. The user interface 116 can also include a plurality of keypads and keys for a variety of functions commonly used on phones.

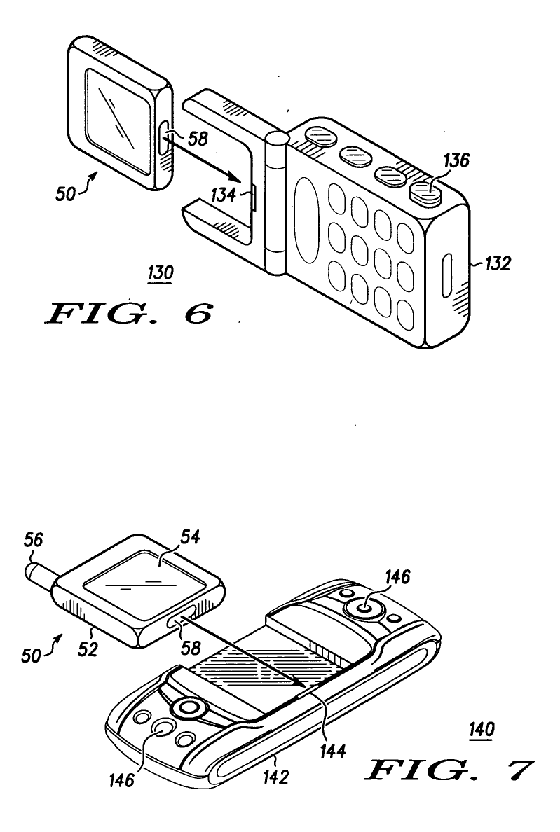

Referring to FIG. 5, a wristwatch radio 120 can include a host portion 122 having a user interface 126 and an interface block 124 for mating with the interface block 58 of the module 50. The user interface 126 can include keys for displaying the time or changing modes on the wristwatch radio 120 or for operating the communication aspects of the wristwatch radio 120. Likewise, FIG. 6 illustrates a camera or video phone 130 including a host portion 132 having a user interface 136 and an interface block 134 for mating with the interface block 58 of the module 50. The user interface 136 can include keys for operating the camera or video phone 130 or for operating the communication aspects of the camera or video phone 130.

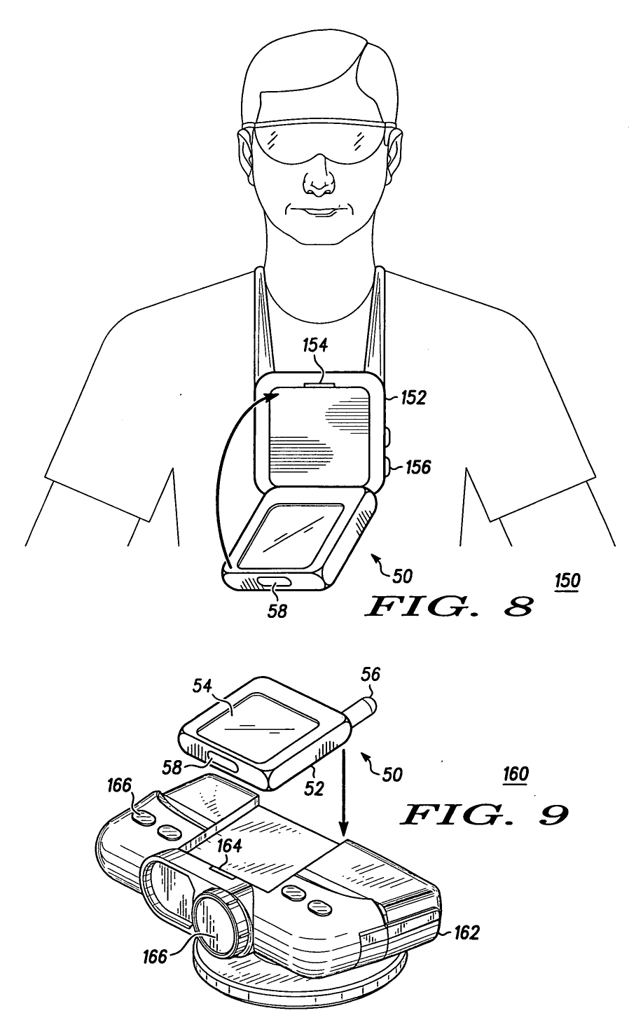

Referring to FIG. 7, a QWERTY keyboard host device 140 illustrates a device including a host portion 142 having a user interface 146 and an interface block 144 for mating with the interface block 58 of the module 50. The user interface 146 can include keys and keypads for operating the communication aspects or other aspects of the host device 140. Referring to FIG. 8, a pendant shaped host device 150 includes a host portion 152 having a user interface 156 and an interface block 154 for mating with the interface block 58 of the module 50. Likewise, a gaming host device 160 shown in FIG. 9 includes a host portion 162 having a user interface 166 and an interface block 164 for mating with the interface block 58 of the module 50.

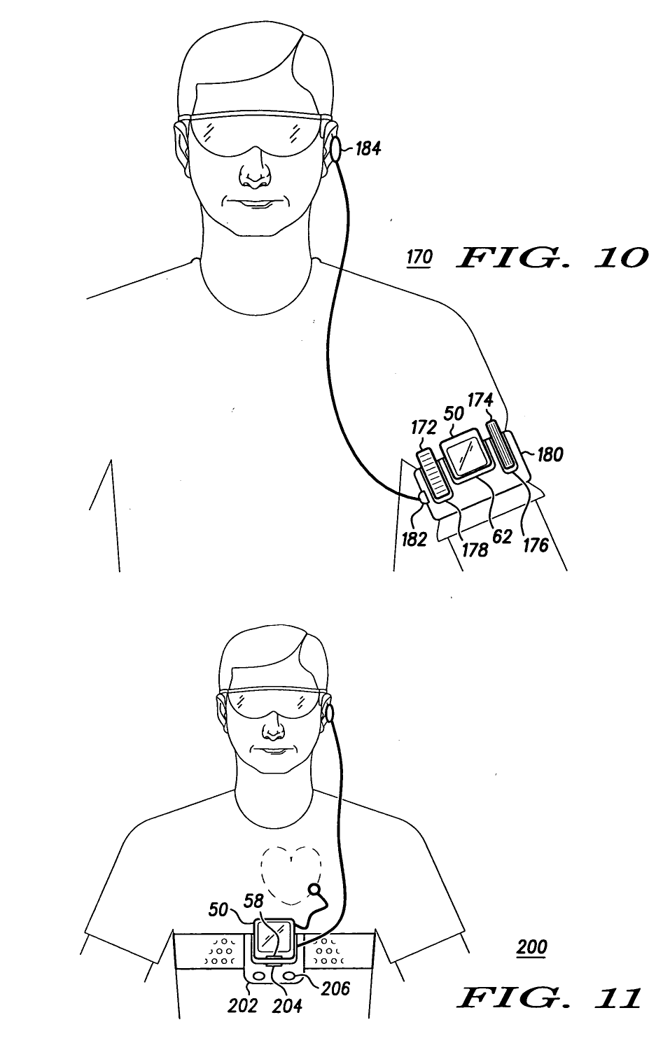

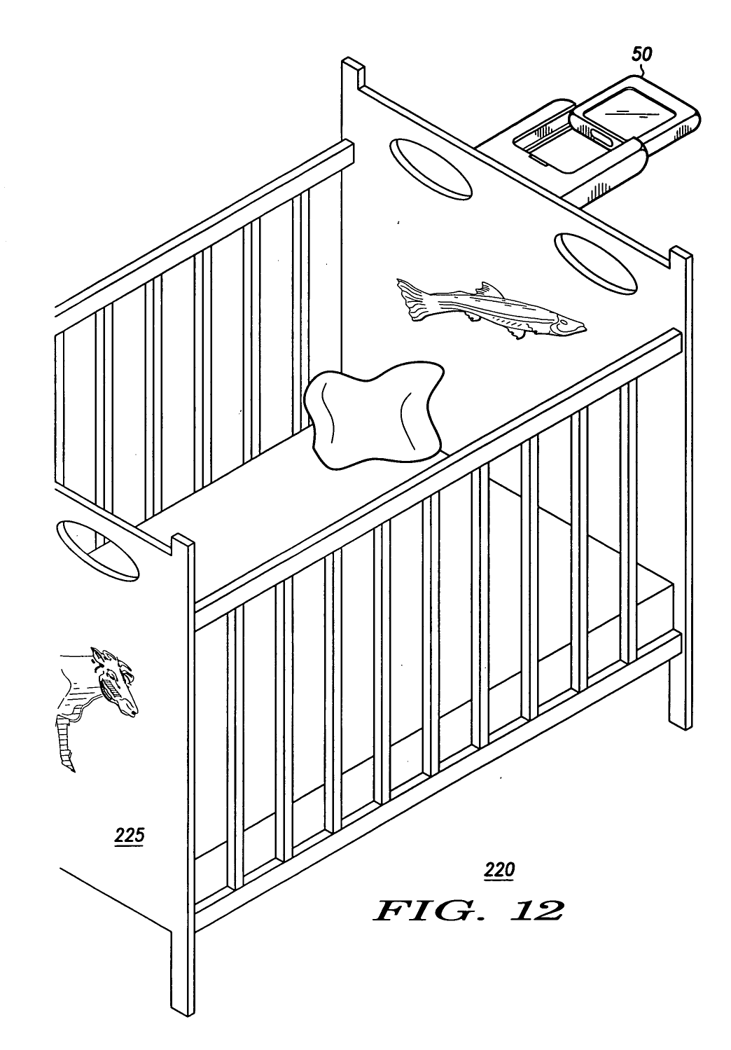

Referring to FIG. 10, an MP3 player 170 can include a host portion or carrier 180 having a plurality of interfaces, ports, and/or cradles for receiving various portions of the player 170. For example, a port or cradle 178 on the carrier 180 can receive a stand-alone MP3 player 172. Another port or cradle 176 can receive removable flash memory 174. Another port 62 can receive the adaptable communication module 50. The carrier 180 can also include a port 182 for plugging in an earpiece 184. In yet another configuration, the module 50 can mate with a heart rate monitor host device 202 as shown in FIG. 11 to form a heart rate monitor radio 200. The host device 202 can have an interface 204 for mating with the interface block 58 of the module 50, electrodes for monitoring the heart, and a user interface 206 for operating the monitoring and communication functions of the hear rate monitor radio 200.

As noted above, the configuration of the possible host devices are numerous. Further note that the concept of a modular communication module can also be adapted for use with other devices that are not necessarily traditionally considered electronic. Toys are a great example of such category of products. In particular, parents of children have demonstrated a need to communicate with their children remotely, to track their child's location, or to locate the child when lost. Rather than give the child a mobile phone to carry or make the child wear a tracking wrist-bracelet device, the communication functionality can be placed into a child's toy using the exemplary embodiments herein. The user can simply insert and remove the electronic module from the toy. As a child grows, the user can remove the communication module from the old toy and place it into a new toy. The child will likely be more compelled to bring a toy with them, rather than a mere phone that is not as attention grabbing.

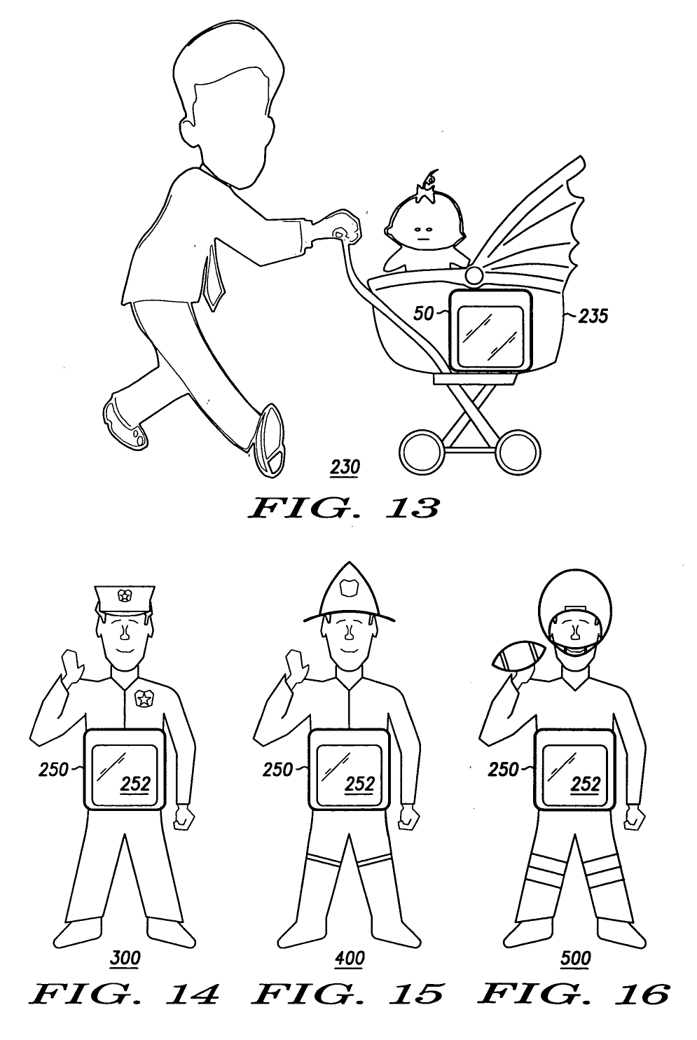

In another embodiment of the present invention, the adaptable communication module can conceivably be used by a particular user from childbirth until adulthood. Starting with infants, a baby crib 225 serving as a host device could be outfitted with the adaptable communication module 50 to allow the module to function as a baby monitor in a system 220 as shown in FIG. 12. The module 50 could also interface to a stroller 235 for an on board education and entertainment system 230 as shown in FIG. 13. As the child grows, the parent can insert the module 50 into different age appropriate toys or into the favorite toy of the day. The toy may provide the user interface, battery, and audio or presentation components. In this manner, the expensive electronics in multiple toys are not duplicated and the technology grows with the child.

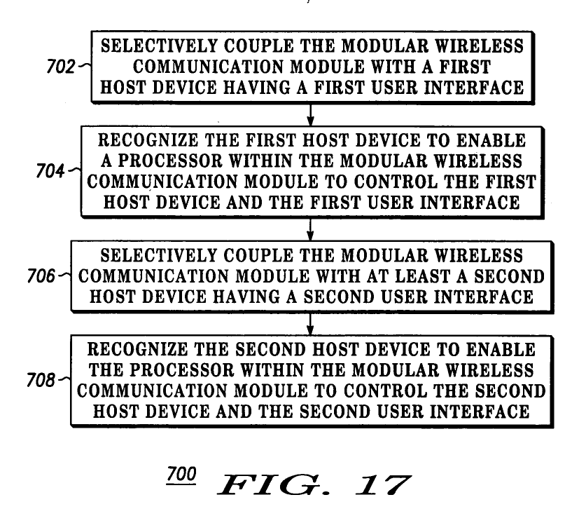

Referring to FIGS. 14-16, exemplary toys using an adaptable communication module 250 is shown having a display 252. Figurines or dolls of different themes can be used. For example, a figurine 300 can be a police officer, a figurine 400 can be a firefighter, and a figurine 500 can be a football player. By inserting the communication module 250, the user transforms a child's toy in the form of a figurine or even a teddy bear into a walkie-talkie or cell phone. Since the child is playing with the toy, they do not need to carry a traditional phone. The communication module 250 simply connects into whichever toy the child wants to use for that given time or activity. By keeping the more expensive components in the communication module 250, the user does not pay for having an LCD, RF chip, etc. in each toy.

Referring to FIG. 17, a flow chart illustrating a method 700 of reusing a modular wireless communication module among a plurality of different host devices is shown. The method can include the step 702 of selectively coupling the modular wireless communication module with a first host device having a first user interface and the step 704 of recognizing the first host device to enable a processor within the modular wireless communication module to control the first host device and the first user interface. The method 700 can further include the step 706 of selectively coupling the modular wireless communication module with at least a second host device having a second user interface and the step 708 of recognizing the second host device to enable the processor within the modular wireless communication module to control the second host device and the second user interface. Note that the first and second host devices and their respective user interfaces can appear and function differently from each other.

In light of the foregoing description, it should be recognized that embodiments in accordance with the present invention can be realized in hardware, software, or a combination of hardware and software. A communications system or device according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

Additionally, the description above is intended by way of example only and is not intended to limit the present invention in any way, except as set forth in the following claims.

1. A modular wireless communication module, comprising:
a transceiver coupled to a processor and memory; and
an interface block coupled to the processor, wherein the processor is programmed to operate in accordance with an identifier signal received from at least one among a plurality of host devices each having different user interfaces.

2. The modular wireless communication module of claim 1, wherein the module further comprises a digital signal processor coupled to the processor.

3. The modular wireless communication module of claim 1, wherein the module further comprises a display coupled to the processor.

4. The modular wireless communication module of claim 3, wherein the display presents content associated with a given host device among the plurality of host devices.

5. The modular wireless communication module of claim 1, wherein the processor controls the operation of a given host device once coupled to the given host device.

6. The modular wireless communication module of claim 1, wherein the module further comprises an antenna coupled to the transceiver.

7. A modular communication system, comprising:
a modular wireless communication module having a transceiver coupled to a processor and memory, and a first interface block coupled to the processor;
a host device having a power source, a user interface, and a second interface block, wherein the host device is one among a plurality of host devices having different user interfaces and the processor is adaptable to control the different user interfaces when the first interface block recognizes the second interface block of a given host device.

8. The modular communication system of claim 7, wherein the modular wireless communication module further comprises a digital signal processor coupled to the processor.

9. The modular communication system of claim 7, wherein the modular wireless communication module further comprises a display coupled to the processor.

10. The modular communication system of claim 9, wherein the display presents content associated with a given host device among the plurality of host devices.

11. The modular communication system of claim 7, wherein the processor controls the operation of a given host device once coupled to the given host device.

12. The modular communication system of claim 7, wherein the module further comprises an antenna coupled to the transceiver.

13. The modular communication system of claim 7, wherein a given host device among the plurality of host devices is selected from the group of a monolith phone, a flip phone, a wristwatch communicator, a camera phone, a video phone, a qwerty key-board host device, a pendant-shaped host device, an MP3 player device, a heart rate monitor, a game controller host, a toy, a stroller, and a crib.

14. An adaptable communication module, comprising:
a radio communication transceiver having a processor programmed to operate with and control a plurality of different host devices having different user interfaces; and
an interface block coupled to the processor for detecting at least one among the plurality of host devices.

15. The adaptable communication module of claim 14, wherein the adaptable communication module further comprises a presentation device coupled to the processor for presenting information associated with the adaptable communication module and a given host device among the plurality of host devices.

16. The adaptable communication module of claim 15, wherein the presentation device is selected from among a display and a speaker.

17. The adaptable communication module of claim 14, wherein the plurality of host devices each includes an interface block for interfacing with the interface block of the adaptable communication module.

18. The adaptable communication module of claim 14, wherein a given host device among the plurality of host devices is selected from the group of a monolith phone, a flip phone, a wristwatch communicator, a camera phone, a video phone, a qwerty key-board host device, a pendant-shaped host device, an MP3 player sport device, a heart rate monitor, a game controller host, a toy, a stroller, and a crib.

19. A host device for mating with a modular wireless communication module having a first interface block and a transceiver coupled to a processor, comprising:
a power source;
a user interface coupled to the power source; and
a second interface block, wherein the host device is one among a plurality of host devices having different user interfaces controlled by the processor when the first interface block recognizes the second interface block of the host device.

20. A method of reusing a modular wireless communication module among a plurality of different host devices, comprising:
selectively coupling the modular wireless communication module with a first host device having a first user interface;
recognizing the first host device to enable a processor within the modular wireless communication module to control the first host device and the first user interface;
selectively coupling the modular wireless communication module with at least a second host device having a second user interface; and
recognizing the second host device to enable the processor within the modular wireless communication module to control the second host device and the second user interface.
